(19) United States
(12) Patent Application Publication
(10) Pub. No.: US 2024/0155460 A1
(43) Pub. Date: May 9, 2024

(54) UE OPERATION METHOD RELATED TO SIDELINK PDB IN WIRELESS COMMUNICATION SYSTEM

(71) Applicant: LG ELECTRONICS INC., Seoul (KR)

(72) Inventors: Seoyoung BACK, Seoul (KR); Giwon PARK, Seoul (KR); Seungmin LEE, Seoul (KR); Jongwoo HONG, Seoul (KR)

(21) Appl. No.: 18/280,444

(22) PCT Filed: Mar. 7, 2022
(86) PCT No.: PCT/KR2022/003165

§ 371 Date: Sep. 5, 2023

Related U.S. Application Data
(60) Provisional application No. 63/169,790, filed on Apr. 1, 2021.

(30) Foreign Application Priority Data
Mar. 5, 2021 (KR) 10-2021-0029574
Mar. 25, 2021 (KR) 10-2021-0038722
Sep. 24, 2021 (KR) 10-2021-0126678

(51) Int. Cl. H04W 40/22

(52) U.S. Cl. CPC H04W 40/22; H04W 88/04

(57) ABSTRACT

An embodiment relates to a sidelink-related operation method of a base station in a wireless communication system, the method comprising: receiving a measurement report by a base station; and configuring a packet delay budget (PDB) by the base station on the basis of the measurement report, wherein the measurement report includes a channel busy ratio (CBR) measurement result, and the PDB includes a PC5 PDB between a relay UE and a remote UE.

### CROSS-REFERENCE TO RELATED APPLICATIONS

This application is a National Phase application under 35 U.S.C. 371 of International Application No. PCT/KR2022/003165, filed on Mar. 7, 2022, which claims the benefit of and priority to Korean Application No. 10-2021-0029574, filed on Mar. 5, 2021, Korean Application No. 10-2021-0038722, filed on Mar. 25, 2021 and Korean Application No. 10-2021-0126678, filed on Sep. 24, 2021, and U.S. Provisional Application No. 63/169,790, filed on Apr. 1, 2021, the contents of which are incorporated by reference herein in their entirety.

### TECHNICAL FIELD

The following description relates to a wireless communication system, and more particularly, to a method and apparatus related to a sidelink packet delay budget (PDB).

### BACKGROUND

Wireless communication systems are being widely deployed to provide various types of communication services such as voice and data. In general, a wireless communication system is a multiple access system capable of supporting communication with multiple users by sharing available system resources (bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system, and a multi carrier frequency division multiple access (MC-FDMA) system.

A wireless communication system uses various radio access technologies (RATs) such as long term evolution (LTE), LTE-advanced (LTE-A), and wireless fidelity (WiFi). 5th generation (5G) is such a wireless communication system. Three key requirement areas of 5G include (1) enhanced mobile broadband (eMBB), (2) massive machine type communication (mMTC), and (3) ultra-reliable and low latency communications (URLLC). Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is augmented reality (AR) for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup can be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G

Finally, logistics and freight tracking are important use cases for mobile communications that enable the tracking of inventory and packages wherever they are by using location-based information systems. The logistics and freight tracking use cases typically require lower data rates but need wide coverage and reliable location information.

A wireless communication system is a multiple access system that supports communication of multiple users by sharing available system resources (a bandwidth, transmission power, etc.). Examples of multiple access systems include a CDMA system, an FDMA system, a TDMA system, an OFDMA system, an SC-FDMA system, and an MC-FDMA system.

Sidelink (SL) refers to a communication scheme in which a direct link is established between user equipments (UEs) and the UEs directly exchange voice or data without intervention of a base station (BS). SL is considered as a solution of relieving the BS of the constraint of rapidly growing data traffic.

Vehicle-to-everything (V2X) is a communication technology in which a vehicle exchanges information with another vehicle, a pedestrian, and infrastructure by wired/wireless communication. V2X may be categorized into four types: vehicle-to-vehicle (V2V), vehicle-to-infrastructure (V2I), vehicle-to-network (V2N), and vehicle-to-pedestrian (V2P). V2X communication may be provided via a PC5 interface and/or a Uu interface.

As more and more communication devices demand larger communication capacities, there is a need for enhanced mobile broadband communication relative to existing RATs. Accordingly, a communication system is under discussion, for which services or UEs sensitive to reliability and latency are considered. The next-generation RAT in which eMBB, MTC, and URLLC are considered is referred to as new RAT or NR. In NR, V2X communication may also be supported.

FIG. 1 is a diagram illustrating V2X communication based on pre-NR RAT and V2X communication based on NR in comparison.

For V2X communication, a technique of providing safety service based on V2X messages such as basic safety message (BSM), cooperative awareness message (CAM), and decentralized environmental notification message (DENM) was mainly discussed in the pre-NR RAT. The V2X message may include location information, dynamic information, and attribute information. For example, a UE may transmit a CAM of a periodic message type and/or a DENM of an event-triggered type to another UE.

For example, the CAM may include basic vehicle information including dynamic state information such as a direction and a speed, vehicle static data such as dimensions, an external lighting state, path details, and so on. For example, the UE may broadcast the CAM which may have a latency less than 100 ms. For example, when an unexpected incident occurs, such as breakage or an accident of a vehicle, the UE may generate the DENM and transmit the DENM to another UE. For example, all vehicles within the transmission range of the UE may receive the CAM and/or the DENM. In this case, the DENM may have priority over the CAM.

In relation to V2X communication, various V2X scenarios are presented in NR. For example, the V2X scenarios include vehicle platooning, advanced driving, extended sensors, and remote driving.

For example, vehicles may be dynamically grouped and travel together based on vehicle platooning. For example, to perform platoon operations based on vehicle platooning, the vehicles of the group may receive periodic data from a leading vehicle. For example, the vehicles of the group may widen or narrow their gaps based on the periodic data.

For example, a vehicle may be semi-automated or full-automated based on advanced driving. For example, each vehicle may adjust a trajectory or maneuvering based on data obtained from a nearby vehicle and/or a nearby logical entity. For example, each vehicle may also share a dividing intention with nearby vehicles.

Based on extended sensors, for example, raw or processed data obtained through local sensor or live video data may be exchanged between vehicles, logical entities, terminals of pedestrians and/or V2X application servers. Accordingly, a vehicle may perceive an advanced environment relative to an environment perceivable by its sensor.

Based on remote driving, for example, a remote driver or a V2X application may operate or control a remote vehicle on behalf of a person incapable of driving or in a dangerous environment. For example, when a path may be predicted as in public transportation, cloud computing-based driving may be used in operating or controlling the remote vehicle. For example, access to a cloud-based back-end service platform may also be used for remote driving.

A scheme of specifying service requirements for various V2X scenarios including vehicle platooning, advanced driving, extended sensors, and remote driving is under discussion in NR-based V2X communication.

### SUMMARY

Embodiment(s) are to provide a method of configuring/reconfiguring a packet delay budget (PDB) in consideration of a channel busy ratio (CBR) in relation to sidelink relay operation.

In an aspect of the present disclosure, there is provided a sidelink related operation method for a base station (BS) in a wireless communication system. The method may include: receiving, by the BS, a measurement report; and configuring, by the BS, a packet delay budget (PDB) based on the measurement report. The measurement report may include a result of measuring a channel busy ratio (CBR), and the PDB may include a PC5 PDB between a relay user equipment (UE) and a remote UE.

In another aspect of the present disclosure, there is provided a BS in a wireless communication system. The BS may include: at least one processor; and at least one computer memory operably connected to the at least one processor and configured to store instructions that, when executed, cause the at least one processor to perform operations. The operations may include: receiving a measurement report; and configuring a PDB based on the measurement report. The measurement report may include a result of measuring a CBR, and the PDB may include a PC5 PDB between a relay UE and a remote UE.

In another aspect of the present disclosure, there is provided a processor configured to perform operations for a BS in a wireless communication system. The operations may include: receiving a measurement report; and configuring a PDB based on the measurement report. The measurement report may include a result of measuring a CBR, and the PDB may include a PC5 PDB between a relay UE and a remote UE.

In another aspect of the present disclosure, there is provided a non-volatile computer-readable storage medium configured to store at least one computer program comprising instructions that, when executed by at least one processor, cause the at least one processor to perform operations for a transmitting user equipment (TX UE). The operations may include: receiving a measurement report; and configuring a PDB based on the measurement report. The measurement report may include a result of measuring a CBR, and the PDB may include a PC5 PDB between a relay UE and a remote UE.

In another aspect of the present disclosure, there is provided a sidelink related operation method for a relay UE in a wireless communication system. The method may include: transmitting a measurement report to a BS; and receiving a PDB configured based on the measurement report from the BS. The measurement report may include a result of measuring a CBR, and the PDB may include a PC5 PDB between the relay UE and a remote UE.

In a further aspect of the present disclosure, there is provided a relay UE in a wireless communication system. The relay UE may include: at least one processor; and at least one computer memory operably connected to the at least one processor and configured to store instructions that, when executed, cause the at least one processor to perform operations. The operations may include: transmitting a measurement report to a BS; and receiving a PDB configured based on the measurement report from the BS. The measurement report may include a result of measuring a CBR, and the PDB may include a PC5 PDB between the relay UE and a remote UE.

The PDB may further include a Uu PDB between the relay UE and the BS.

Configuring the PDB may include dividing a total PDB into the PC5 PDB and a Uu PDB.

The CBR may be measured by the remote UE.

The CBR may be received by the BS from the relay UE.

The BS may increase the PC5 PDB based on an increase in the CBR.

The BS may readjust a fifth generation (5G) quality of service (QoS) identifier (5QI)/PC5 5QI mapping rule to reduce the Uu PDB.

The PDB may be independently configured for each logical channel, bearer, or service type.

The relay UE may communicate with at least one of another UE, a UE related to an autonomous vehicle, a BS, or a network.

According to an embodiment, a PC5 packet delay budget (PDB) and a Uu PDB may be re-adjusted/reallocated in consideration of the channel busy ratio (CBR) of a sidelink. Thus, the total PDB may be satisfied by dynamically reflecting sidelink communication environments.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram comparing vehicle-to-everything (V2X) communication based on pre-new radio access technology (pre-NR) with V2X communication based on NR;

FIG. 2 is a diagram illustrating the structure of a long term evolution (LTE) system according to an embodiment of the present disclosure;

FIG. 3 is a diagram illustrating user-plane and control-plane radio protocol architectures according to an embodiment of the present disclosure;

FIG. 4 is a diagram illustrating the structure of an NR system according to an embodiment of the present disclosure;

FIG. 5 is a diagram illustrating functional split between a next generation radio access network (NG-RAN) and a 5th generation core network (5GC) according to an embodiment of the present disclosure;

FIG. 6 is a diagram illustrating the structure of an NR radio frame to which embodiment(s) of the present disclosure is applicable;

FIG. 7 is a diagram illustrating a slot structure of an NR frame according to an embodiment of the present disclosure;

FIG. 8 is a diagram illustrating radio protocol architectures for sidelink (SL) communication according to an embodiment of the present disclosure;

FIG. 9 is a diagram illustrating radio protocol architectures for SL communication according to an embodiment of the present disclosure;

FIG. 10 is a diagram illustrating a procedure for performing V2X or SL communication by a UE according to a transmission mode;

FIGS. 11 to 14 are diagrams for explaining embodiment(s); and

FIGS. 15 to 21 are diagrams for explaining various devices to which embodiment(s) are applicable.

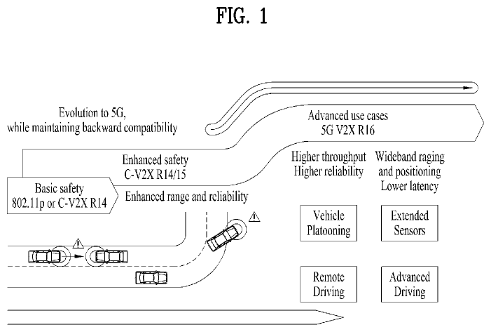

### DETAILED DESCRIPTION

In various embodiments of the present disclosure, “/” and “,” should be interpreted as “and/or”. For example, “A/B” may mean “A and/or B”. Further, “A, B” may mean “A and/or B”. Further, “A/B/C” may mean “at least one of A, B and/or C”. Further, “A, B, C” may mean “at least one of A, B and/or C”.

In various embodiments of the present disclosure, “or” should be interpreted as “and/or”. For example, “A or B” may include “only A”, “only B”, and/or “both A and B”. In other words, “or” should be interpreted as “additionally or alternatively”.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA), or the like. IEEE 802.16m is an evolution of IEEE 802.16e, offering backward compatibility with an IRRR 802.16e-based system. UTRA is a part of universal mobile telecommunications system (UMTS). 3rd generation partnership project (3GPP) long term evolution (LTE) is a part of evolved UMTS (E-UMTS) using evolved UTRA (E-UTRA). 3GPP LTE employs OFDMA for downlink (DL) and SC-FDMA for uplink (UL). LTE-advanced (LTE-A) is an evolution of 3GPP LTE.

A successor to LTE-A, 5th generation (5G) new radio access technology (NR) is a new clean-state mobile communication system characterized by high performance, low latency, and high availability. 5G NR may use all available spectral resources including a low frequency band below 1 GHz, an intermediate frequency band between 1 GHz and 10 GHz, and a high frequency (millimeter) band of 24 GHz or above.

While the following description is given mainly in the context of LTE-A or 5G NR for the clarity of description, the technical idea of an embodiment of the present disclosure is not limited thereto.

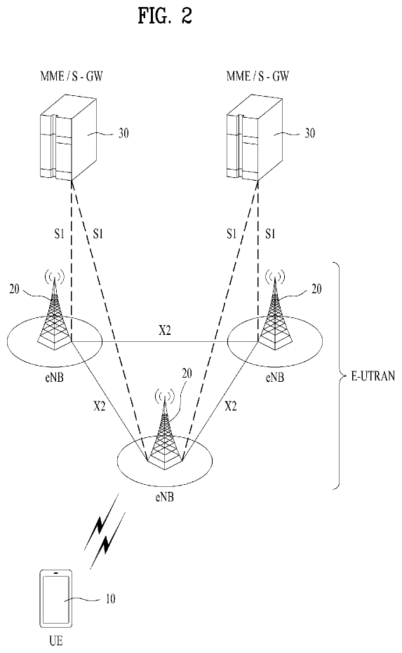

FIG. 2 illustrates the structure of an LTE system according to an embodiment of the present disclosure. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

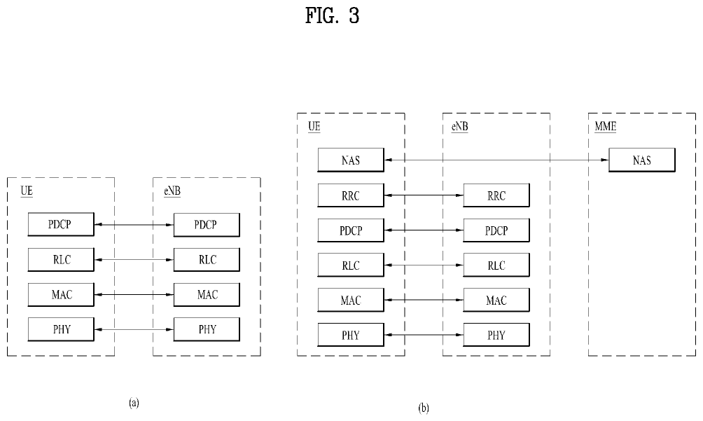

FIG. 3(a) illustrates a user-plane radio protocol architecture according to an embodiment of the disclosure.

FIG. 3(b) illustrates a control-plane radio protocol architecture according to an embodiment of the disclosure. A user plane is a protocol stack for user data transmission, and a control plane is a protocol stack for control signal transmission.

Referring to FIGS. 3(a) and 3(b), the PHY layer provides an information transfer service to its higher layer on physical channels. The PHY layer is connected to the medium access control (MAC) layer through transport channels and data is transferred between the MAC layer and the PHY layer on the transport channels. The transport channels are divided according to features with which data is transmitted via a radio interface.

Data is transmitted on physical channels between different PHY layers, that is, the PHY layers of a transmitter and a receiver. The physical channels may be modulated in orthogonal frequency division multiplexing (OFDM) and use time and frequencies as radio resources.

The MAC layer provides services to a higher layer, radio link control (RLC) on logical channels. The MAC layer provides a function of mapping from a plurality of logical channels to a plurality of transport channels. Further, the MAC layer provides a logical channel multiplexing function by mapping a plurality of logical channels to a single transport channel A MAC sublayer provides a data transmission service on the logical channels.

The RLC layer performs concatenation, segmentation, and reassembly for RLC serving data units (SDUs). In order to guarantee various quality of service (QoS) requirements of each radio bearer (RB), the RLC layer provides three operation modes, transparent mode (TM), unacknowledged mode (UM), and acknowledged Mode (AM). An AM RLC provides error correction through automatic repeat request (ARQ).

The RRC layer is defined only in the control plane and controls logical channels, transport channels, and physical channels in relation to configuration, reconfiguration, and release of RBs. An RB refers to a logical path provided by L1 (the PHY layer) and L2 (the MAC layer, the RLC layer, and the packet data convergence protocol (PDCP) layer), for data transmission between the UE and the network.

The user-plane functions of the PDCP layer include user data transmission, header compression, and ciphering. The control-plane functions of the PDCP layer include control-plane data transmission and ciphering/integrity protection.

RB establishment amounts to a process of defining radio protocol layers and channel features and configuring specific parameters and operation methods in order to provide a specific service. RBs may be classified into two types, signaling radio bearer (SRB) and data radio bearer (DRB). The SRB is used as a path in which an RRC message is transmitted on the control plane, whereas the DRB is used as a path in which user data is transmitted on the user plane.

Once an RRC connection is established between the RRC layer of the UE and the RRC layer of the E-UTRAN, the UE is placed in RRC_CONNECTED state, and otherwise, the UE is placed in RRC_IDLE state. In NR, RRC_INACTIVE state is additionally defined. A UE in the RRC_INACTIVE state may maintain a connection to a core network, while releasing a connection from an eNB.

DL transport channels carrying data from the network to the UE include a broadcast channel (BCH) on which system information is transmitted and a DL shared channel (DL SCH) on which user traffic or a control message is transmitted. Traffic or a control message of a DL multicast or broadcast service may be transmitted on the DL-SCH or a DL multicast channel (DL MCH). UL transport channels carrying data from the UE to the network include a random access channel (RACH) on which an initial control message is transmitted and an UL shared channel (UL SCH) on which user traffic or a control message is transmitted.

The logical channels which are above and mapped to the transport channels include a broadcast control channel (BCCH), a paging control channel (PCCH), a common control channel (CCCH), a multicast control channel (MCCH), and a multicast traffic channel (MTCH).

A physical channel includes a plurality of OFDM symbol in the time domain by a plurality of subcarriers in the frequency domain. One subframe includes a plurality of OFDM symbols in the time domain An RB is a resource allocation unit defined by a plurality of OFDM symbols by a plurality of subcarriers. Further, each subframe may use specific subcarriers of specific OFDM symbols (e.g., the first OFDM symbol) in a corresponding subframe for a physical DL control channel (PDCCH), that is, an L1/L2 control channel. A transmission time interval (TTI) is a unit time for subframe transmission.

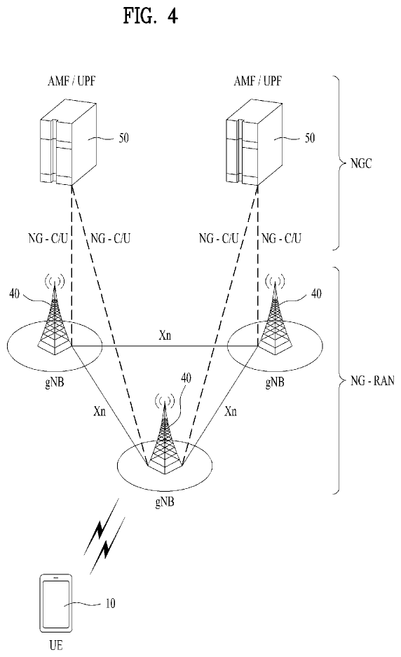

FIG. 4 illustrates the structure of an NR system according to an embodiment of the present disclosure.

Referring to FIG. 4, a next generation radio access network (NG-RAN) may include a next generation Node B (gNB) and/or an eNB, which provides user-plane and control-plane protocol termination to a UE. In FIG. 4, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

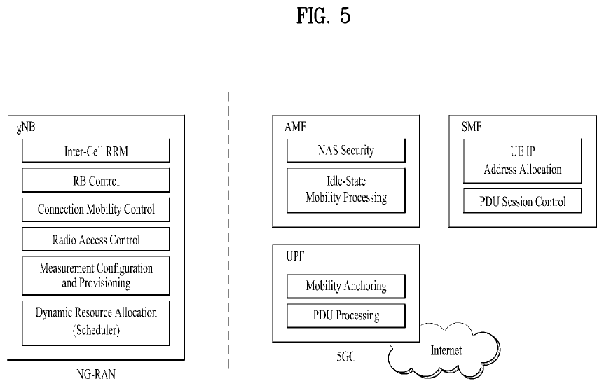

FIG. 5 illustrates functional split between the NG-RAN and the 5GC according to an embodiment of the present disclosure.

Referring to FIG. 5, a gNB may provide functions including inter-cell radio resource management (RRM), radio admission control, measurement configuration and provision, and dynamic resource allocation. The AMF may provide functions such as non-access stratum (NAS) security and idle-state mobility processing. The UPF may provide functions including mobility anchoring and protocol data unit (PDU) processing. A session management function (SMF) may provide functions including UE Internet protocol (IP) address allocation and PDU session control.

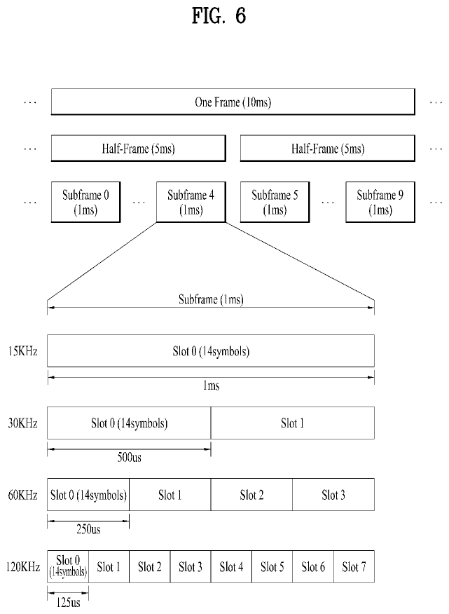

FIG. 6 illustrates a radio frame structure in NR, to which embodiment(s) of the present disclosure is applicable.

Referring to FIG. 6, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM(A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot (N^{slot}_{symb}), the number of slots per frame (N^{frame,u}ₛₗₒₜ), and the number of slots per subframe (N^{subframe,u}ₛₗₒₜ) according to an SCS configuration μ in the NCP case.

TABLE 1

| SCS (15*2u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In the NR system, different OFDM(A) numerologies (e.g., SCSs, CP lengths, and so on) may be configured for a plurality of cells aggregated for one UE. Accordingly, the (absolute time) duration of a time resource including the same number of symbols (e.g., a subframe, slot, or TTI) (collectively referred to as a time unit (TU) for convenience) may be configured to be different for the aggregated cells.

In NR, various numerologies or SCSs may be supported to support various 5G services. For example, with an SCS of 15 kHz, a wide area in traditional cellular bands may be supported, while with an SCS of 30/60 kHz, a dense urban area, a lower latency, and a wide carrier bandwidth may be supported. With an SCS of 60 kHz or higher, a bandwidth larger than 24.25 GHz may be supported to overcome phase noise.

An NR frequency band may be defined by two types of frequency ranges, FR1 and FR2. The numerals in each frequency range may be changed. For example, the two types of frequency ranges may be given in [Table 3]. In the NR system, FR1 may be a “sub 6 GHz range” and FR2 may be an “above 6 GHz range” called millimeter wave (mmW).

TABLE 3

| Frequency Range | Corresponding | Subcarrier |
|---|---|---|
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As mentioned above, the numerals in a frequency range may be changed in the NR system. For example, FR1 may range from 410 MHz to 7125 MHz as listed in [Table 4]. That is, FR1 may include a frequency band of 6 GHz (or 5850, 5900, and 5925 MHz) or above. For example, the frequency band of 6 GHz (or 5850, 5900, and 5925 MHz) or above may include an unlicensed band. The unlicensed band may be used for various purposes, for example, vehicle communication (e.g., autonomous driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

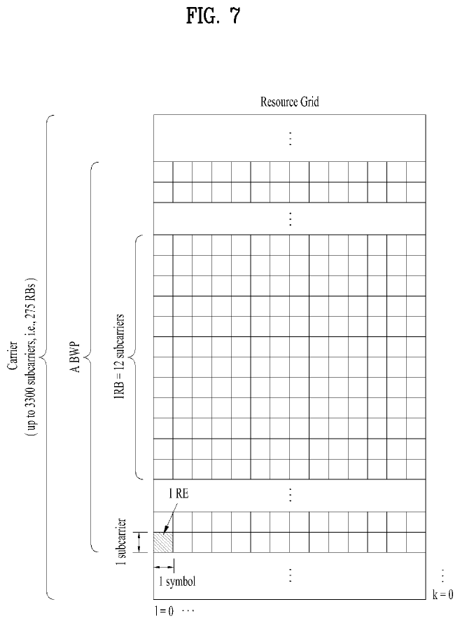

FIG. 7 illustrates a slot structure in an NR frame according to an embodiment of the present disclosure.

Referring to FIG. 7, a slot includes a plurality of symbols in the time domain. For example, one slot may include 14 symbols in an NCP case and 12 symbols in an ECP case. Alternatively, one slot may include 7 symbols in an NCP case and 6 symbols in an ECP case.

A carrier includes a plurality of subcarriers in the frequency domain. An RB may be defined by a plurality of (e.g., 12) consecutive subcarriers in the frequency domain A bandwidth part (BWP) may be defined by a plurality of consecutive (physical) RBs ((P)RBs) in the frequency domain and correspond to one numerology (e.g., SCS, CP length, or the like). A carrier may include up to N (e.g., 5) BWPs. Data communication may be conducted in an activated BWP. Each element may be referred to as a resource element (RE) in a resource grid, to which one complex symbol may be mapped.

A radio interface between UEs or a radio interface between a UE and a network may include L1, L2, and L3. In various embodiments of the present disclosure, L1 may refer to the PHY layer. For example, L2 may refer to at least one of the MAC layer, the RLC layer, the PDCH layer, or the SDAP layer. For example, L3 may refer to the RRC layer.

Now, a description will be given of sidelink (SL) communication.

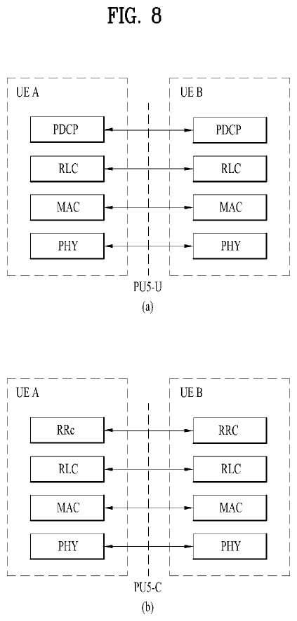

FIG. 8 illustrates a radio protocol architecture for SL communication according to an embodiment of the present disclosure. Specifically, FIG. 8(a) illustrates a user-plane protocol stack in LTE, and FIG. 8(b) illustrates a control-plane protocol stack in LTE.

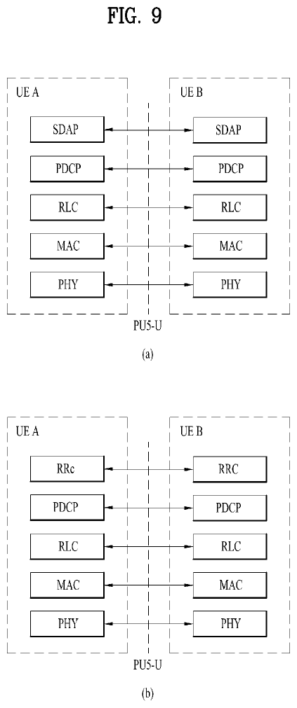

FIG. 9 illustrates a radio protocol architecture for SL communication according to an embodiment of the present disclosure. Specifically, FIG. 9(a) illustrates a user-plane protocol stack in NR, and FIG. 9(b) illustrates a control-plane protocol stack in NR.

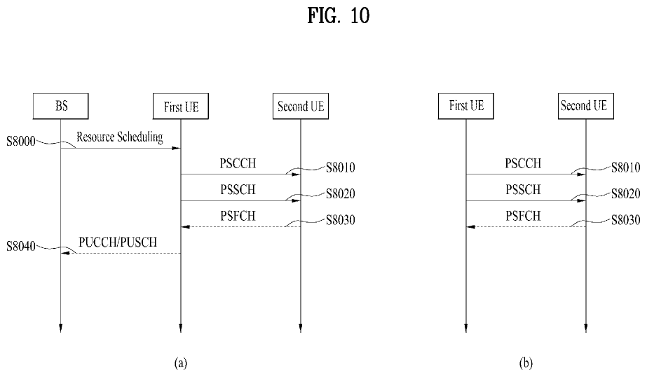

FIG. 10 illustrates a procedure of performing V2X or SL communication by a UE depending on a transmission mode according to an embodiment of the present disclosure. The embodiment of FIG. 10 may be combined with various embodiments of the present disclosure. In various embodiments of the present disclosure, a transmission mode may be referred to as a mode or a resource allocation mode. For the convenience of the following description, a transmission mode in LTE may be referred to as an LTE transmission mode, and a transmission mode in NR may be referred to as an NR resource allocation mode.

For example, FIG. 10(a) illustrates a UE operation related to LTE transmission mode 1 or LTE transmission mode 3. Alternatively, for example, FIG. 10(a) illustrates a UE operation related to NR resource allocation mode 1. For example, LTE transmission mode 1 may apply to general SL communication, and LTE transmission mode 3 may apply to V2X communication.

For example, FIG. 10(b) illustrates a UE operation related to LTE transmission mode 2 or LTE transmission mode 4. Alternatively, for example, FIG. 10(b) illustrates a UE operation related to NR resource allocation mode 2.

Referring to FIG. 10(a), in LTE transmission mode 1, LTE transmission mode 3, or NR resource allocation mode 1, a BS may schedule an SL resource to be used for SL transmission by a UE. For example, in step S8000, the BS may transmit information related to an SL resource and/or information related to a UE resource to a first UE. For example, the UL resource may include a physical uplink control channel (PUCCH) resource and/or a physical uplink shared channel (PUSCH) resource. For example, the UL resource may be a resource to report SL HARQ feedback to the BS.

For example, the first UE may receive information related to a Dynamic Grant (DG) resource and/or information related to a Configured Grant (CG) resource from the BS. For example, the CG resource may include a CG type 1 resource or a CG type 2 resource. In the present specification, the DG resource may be a resource that the BS configures/allocates to the first UE in Downlink Control Information (DCI). In the present specification, the CG resource may be a (periodic) resource configured/allocated by the BS to the first UE in DCI and/or an RRC message. For example, for the CG type 1 resource, the BS may transmit an RRC message including information related to the CG resource to the first UE. For example, for the CG type 2 resource, the BS may transmit an RRC message including information related to the CG resource to the first UE, and the BS may transmit DCI related to activation or release of the CG resource to the first UE.

In step S8010, the first UE may transmit a physical sidelink control channel (PSCCH) (e.g., Sidelink Control Information (SCI) or 1st-stage SCI) to a second UE based on the resource scheduling. In step S8020, the first UE may transmit a physical sidelink shared channel (PSSCH) (e.g., 2nd-stage SCI, MAC PDU, data, etc.) related to the PSCCH to the second UE. In step S8030, the first UE may receive a physical sidelink feedback channel (PSFCH) related to the PSCCH/PSSCH from the second UE. For example, HARQ feedback information (e.g., NACK information or ACK information) may be received from the second UE over the PSFCH. In step S8040, the first UE may transmit/report HARQ feedback information to the BS over a PUCCH or PUSCH. For example, the HARQ feedback information reported to the BS may include information generated by the first UE based on HARQ feedback information received from the second UE. For example, the HARQ feedback information reported to the BS may include information generated by the first UE according to a predetermined rule. For example, the DCI may be DCI for scheduling of SL. For example, the format of the DCI may include DCI format 3_0 or DCI format 3_1. Table 5 shows one example of DCI for scheduling of SL.

TABLE 5
7.3.1.4.1 Format 3_0
DCI format 3_0 is used for scheduling of NR PSCCH and NR PSSCH in one cell.
The following information is transmitted by means of the DCI format 3_0 with CRC
scrambled by SL-RNTI or SL-CS-RNTI:

| - Resource pool index −[log₂ I] bits, where I is the number of resource pools for | |
|---|---|
| transmission configured by the higher layer parameter sl-TxPoolScheduling. | |
| - Time gap - 3 bits determined by higher layer parameter sl-DCI-ToSL-Trans, as | |
| defined in clause 8.1.2.1 of [6, TS 38.214] | |
| - HARQ process number - 4 bits. | |
| - New data indicator - 1 bit. | |
| - Lowest index of the subchannel allocation to the initial transmission - | |
| [log₂(N_{subChannel}^{SL})] bits as defined in clause 8.1.2.2 of [6, TS 38.214] | |
| - SCI format 1-A fields according to clause 8.3.1.1: | |
| - | Frequency resource assignment. |
| - | Time resource assignment. |
| - PSFCH-to-HARQ feedback timing indicator −[log₂ N_{fb}_{_{—}}_{timing}] bits, where N_{fb}_{_{—}}_{timing} | |
| is the number of entries in the higher layer parameter sl-PSFCH-ToPUCCH, as defined | |
| in clause 16.5 of [5, TS 38.213] | |
| - PUCCH resource indicator - 3 bits as defined in clause 16.5 of [5, TS 38.213]. | |
| - Configuration index - 0 bit if the UE is not configured to monitor DCI format 3_0 | |
| with CRC scrambled by SL-CS-RNTI; otherwise 3 bits as defined in clause 8.1.2 of [6, | |
| TS 38.214]. If the UE is configured to monitor DCI format 3_0 with CRC scrambled | |
| by SL-CS-RNTI, this field is reserved for DCI format 3_0 with CRC scrambled by SL- | |
| RNTI. | |
| - Counter sidelink assignment index - 2 bits | |
| - | 2 bits as defined in clause 16.5.2 of [5, TS 38.213] if the UE is configured with |
| | pdsch-HARQ-ACK-Codebook = dynamic |
| - | 2 bits as defined in clause 16.5.1 of [5, TS 38.213] if the UE is configured with |
| | pdsch-HARQ-ACK-Codebook = semi-static |

- Padding bits, if required

If multiple transmit resource pools are provided in sl-TxPoolScheduling, zeros shall be
appended to the DCI format 3_0 until the payload size is equal to the size of a DCI format
3_0 given by a configuration of the transmit resource pool resulting in the largest number of
information bits for DCI format 3_0.
If the UE is configured to monitor DCI format 3_1 and the number of information bits in
DCI format 3_0 is less than the payload of DCI format 3_1, zeros shall be appended to DCI
format 3_0 until the payload size equals that of DCI format 3_1.
7.3.1.4.2 Format 3_1
DCI format 3_1 is used for scheduling of LTE PSCCH and LTE PSSCH in one cell.
The following information is transmitted by means of the DCI format 3_1 with CRC
scrambled by SL Semi-Persistent Scheduling V-RNTI.

- Timing offset - 3 bits determined by higher layer parameter sl-TimeOffsetEUTRA-
List, as defined in clause 16.6 of [5, TS 38.213]
- Carrier indicator -3 bits as defined in 5.3.3.1.9A of [11, TS 36.212].
- Lowest index of the subchannel allocation to the initial transmission -
[log₂(N_{subchannel}^{SL} )] bits as defined in 5.3.3.1.9A of [11, TS 36.212].
- Frequency resource location of initial transmission and retransmission, as defined in
5.3.3.1.9A of [11, TS 36.212]
- Time gap between initial transmission and retransmission, as defined in 5.3.3.1.9A of
[11, TS 36.212]
- SL index - 2 bits as defined in 5.3.3.1.9A of [11, TS 36.212]
- SL SPS configuration index - 3 bits as defined in clause 5.3.3.1.9A of [11, TS
36.212].
- Activation/release indication - 1 bit as defined in clause 5.3.3.1.9A of [11, TS
36.212].

Referring to FIG. 10(b), for LTE transmission mode 2, LTE transmission mode 4, or NR resource allocation mode 2, a UE may determine an SL transmission resource from among SL resources configured by a BS/network or preconfigured SL resources. For example, the configured SL resources or preconfigured SL resources may be a resource pool. For example, the UE may autonomously select or schedule resources for SL transmission. For example, the UE may perform SL communication by selecting a resource by itself within a configured resource pool. For example, the UE may perform sensing and resource (re)selection procedures to select a resource by itself within a selection window. For example, the sensing may be performed in unit of a sub-channel For example, in step S8010, the first UE having self-selected a resource in the resource pool may transmit a PSCCH (e.g., Sidelink Control Information (SCI) or 1^{st}-stage SCI) to the second UE using the resource. In step S8020, the first UE may transmit a PSSCH (e.g., 2^{nd}-stage SCI, MAC PDU, data, etc.) related to the PSCCH to the second UE. In step S8030, the first UE may receive a PSFCH related to the PSCCH/PSSCH from the second UE.

Referring to FIG. 10(a) or FIG. 10(b), for example, the first UE may transmit the SCI to the second UE on the PSCCH. Alternatively, for example, the first UE may transmit two consecutive SCIs (e.g., two-stage SCI) to the second UE on the PSCCH and/or PSSCH. In this case, the second UE may decode the two consecutive SCIs (e.g., two-stage SCI) to receive the PSSCH from the first UE. In the present specification, the SCI transmitted on the PSCCH may be referred to as 1st SCI, 1st-stage SCI, or a 1st-stage SCI format, and the SCI transmitted on the PSSCH may be referred to as 2nd SCI, 2nd SCI, or a 2nd-stage SCI format. For example, the 1st-stage SCI format may include SCI format 1-A, and the 2nd-stage SCI format may include SCI format 2-A and/or SCI format 2-B. Table 6 shows one example of a 1st-stage SCI format.

```
TABLE 6
8.3.1.1 SCI format 1-A
SCI format 1-A is used for the scheduling of PSSCH and 2^{nd}-stage-SCI on PSSCH
The following information is transmitted by means of the SCI format 1-A:
  - Priority - 3 bits as specified in clause 5.4.3.3 of [12, TS 23.287] and clause 5.22.1.3.1
  of [8, TS 38.321]. Value ‘000’ of Priority field corresponds to priority value ‘1’, value
  ‘001’ of Priority field corresponds to priority value ‘2’, and so on.
  $- Frequency resource assignment - ⌈ {log}_{2} ( \frac{{N}_{subChannel}^{SL} ( {N}_{subChannel}^{SL} + 1 )}{2} ) ⌉ bits when the value$
  of the higher layer parameter sl-MaxNumPerReserve is configured to 2; otherwise
  $⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ bits when the value of the higher layer$
  parameter sl-MaxNumPerReserve is configured to 3, as defined in clause 8.1.5 of [6,
  TS 38.214].
  - Time resource assignment - 5 bits when the value of the higher layer parameter sl-
  MaxNumPerReserve is configured to 2; otherwise 9 bits when the value of the higher
  layer parameter sl-MaxNumPerReserve is configured to 3, as defined in clause 8.1.5 of
  [6, TS 38.214].
  - Resource reservation period -┌log₂ Nᵣₛᵥ_period┐ bits as defined in clause 16.4 of [5,
  TS 38.213], where Nᵣₛᵥ_period is the number of entries in the higher layer parameter sl-
  ResourceReservePeriodList, if higher layer parameter sl-MultiReserveResource is
  configured; 0 bit otherwise.
  - DMRS pattern - ┌log₂ Nᵣₛᵥ_period┐ bits as defined in clause 8.4.1.1.2 of [4, TS 38.211],
  where Npattern is the number of DMRS patterns configured by higher layer parameter
  sl-PSSCH-DMRS-TimePatternList.
  - 2^{nd}-stage SCI format - 2 bits as defined in Table 8.3.1.1-1.
  - Beta_offset indicator - 2 bits as provided by higher layer parameter sl-
  BetaOffsets2ndSCI and Table 8.3.1.1-2.
  - Number of DMRS port - 1 bit as defined in Table 8.3.1.1-3.
  - Modulation and coding scheme - 5 bits as defined in clause 8.1.3 of [6, TS 38.214].
  - Additional MCS table indicator - as defined in clause 8.1.3.1 of [6, TS 38.214]: 1 bit
  if one MCS table is configured by higher layer parameter sl-Additional-MCS-Table; 2
  bits if two MCS tables are configured by higher layer parameter sl-Additional-MCS-
  Table; 0 bit otherwise.
  - PSFCH overhead indication - 1 bit as defined clause 8.1.3.2 of [6, TS 38.214] if
  higher layer parameter sl-PSFCH-Period = 2 or 4; 0 bit otherwise.
  - Reserved-a number of bits as determined by higher layer parameter sl-
  NumReservedBits, with value set to zero.
```

Table 7 shows one example of a 2nd-stage SCI format.

```
TABLE 7
8.4 Sidelink control information on PSSCH
SCI carried on PSSCH is a 2^{nd}-stage SCI. which transports sidelink scheduling information.
8.4.1 2nd-stage SCI formats
The fields defined in each of the 2^{nd}-stage SCI formats below are mapped to the information
bits a₀ to a_{A-1} as follows:
Each field is mapped in the order in which it appears in the description. with the first field
mapped to the lowest order information bit a₀ and each successive field mapped to higher
order information bits. The most significant bit of each field is mapped to the lowest order
information bit for that field, e.g. the most significant bit of the first field is mapped to a₀.
8.4.1.1 SCI format 2-A
SCI format 2-A is used for the decoding of PSSCH, with HARQ operation when HARQ-ACK
information includes ACK or NACK, when HARQ-ACK information includes only NACK,
or when there is no feedback of HARQ-ACK information.
The following information is transmitted by means of the SCI format 2-A:
  - HARQ process number - 4 bits.
  - New data indicator - 1 bit.
  - Redundancy version - 2 bits as defined in Table 7.3.1.1.1-2.
  - Source ID - 8 bits as defined in clause 8.1 of [6, TS 38.214].
  - Destination ID - 16 bits as defined in clause 8.1 of [6, TS 38.214].
  - HARQ feedback enabled/disabled indicator - 1 bit as defined in clause 16.3 of [5, TS
38.213].
  - Cast type indicator - 2 bits as defined in Table 8.4.1.1-1 and in clause 8.1 of [6, TS
38.214].
  - CSI request - 1 bit as defined in clause 8.2.1 of [6, TS 38.214] and in clause 8.1 of [6,
TS 38.214].
```

Referring to FIG. 10(a) or FIG. 10(b), in step S8030, the first UE may receive the PSFCH based on Table 8. For example, the first UE and the second UE may determine a PSFCH resource based on Table 8, and the second UE may transmit HARQ feedback to the first UE using the PSFCH resource.

TABLE 8
16.3 UE procedure for reporting HARQ-ACK on sidelink
A UE can be indicated by an SCI format scheduling a PSSCH reception to transmit a PSFCH
with HARQ-ACK information in response to the PSSCH reception. The UE provides
HARQ-ACK information that includes ACK or NACK, or only NACK.
A UE can be provided, by sl-PSFCH-Period, a number of slots in a resource pool for a
period of PSFCH transmission occasion resources. If the number is zero, PSFCH
transmissions from UE in the resource pool are disabled.
A UE expects that a slot t′ₖ^{SL} (0 ≤ k < T′ₘₐₓ) has a PSFCH transmission occasion resource
if k mod N_{PSSCH}^{PSFCH} = 0, where t′ₖ^{SL} is defined in [6, TS 38.214], and T′ₘₐₓ is a number of slots
that belong to the resource pool within 10240 msec according to [6, TS 38.214], and N_{PSSCH}^{PSFCH}
is provided by sl-PSFCH-Period.
A UE may be indicated by higher layers to not transmit a PSFCH in response to a PSSCH
reception [11, TS 38.321].
If a UE receives a PSSCH in a resource pool and the HARQ feedback enabled/disabled
indicator field in an associated SCI format 2-A or a SCI format 2-B has value 1 [5, TS
38.212], the UE provides the HARQ-ACK information in a PSFCH transmission in the
resource pool. The UE transmits the PSFCH in a first slot that includes PSFCH resources and
is at least a number of slots, provided by sl-MinTimeGapPSFCH, of the resource pool after a
last slot of the PSSCH reception.
A UE is provided by sl-PSFCH-RB-Set a set of M_{PRB, set}^{PSFCH} PRBs in a resource pool for PSFCH
transmission in a PRB of the resource pool. For a number of N_{subch} sub-channels for the
resource pool, provided by sl-NumSubchannel, and a number of PSSCH slots associated with
a PSFCH slot that is less than or equal to N_{PSSCH}^{PSFCH}, the UE allocates the [(i + j · N_{PSSCH}^{PSFCH}) ·
M_{subch, slot}^{PSFCH}(i + 1 + j · N_{PSSCH}^{PSFCH}) · M_{subch, slot}^{PSFCH} −1] PRBs from the M_{PRB, set}^{PSFCH} PRBs to slot i
among the PSSCH slots associated with the PSFCH slot and sub-channel j, where
M_{subch, slot}^{PSFCH} = M_{PRB, set}^{PSFCH}/(N_{subch} · N_{PSSCH}^{PSFCH}), 0 ≤ i < N_{PSSCH}^{PSFCH}, 0 ≤ j < N_{subch}, and the allocation
starts in an ascending order of i and continues in an ascending order of j. The UE expects
that M_{PRB, set}^{PSFCH} is a multiple of N_{subch} · N_{PSSCH}^{PSFCH}.
The second OFDM symbol l′ of PSFCH transmission in a slot is defined as l′ =
sl-StartSymbol + sl-LengthSymbol − 2.
A UE determines a number of PSFCH resources available for multiplexing HARQ-ACK
information in a PSFCH transmission as R_{PRB, CS}^{PSFCH} = N_{type}^{PSFCH} · M_{subch, slot}^{PSFCH} · N_{CS}^{PSFCH} where
N_{CS}^{PSFCH} is a number of cyclic shift pairs for the resource pool provided by sl-NumMuxCS-
Pair and, based on an indication by sl-PSFCH-CandidateResourceType,

- if sl-PSFCH-CandidateResourceType is configured as startSubCH, N_{type}^{PSFCH} = 1 and
the M_{subch, slot}^{PSFCH} PRBs are associated with the starting sub-channel of the corresponding
PSSCH;
- if sl-PSFCH-CandidateResourceType is configured as allocSubCH, N_{type}^{PSFCH} =
N_{subch}^{PSSCH} and the N_{subch}^{PSSCH} · M_{subch, slot}^{PSFCH} PRBs are associated with the N_{subch, slot}^{PSFCH} sub-channels
of the corresponding PSSCH.

The PSFCH resources are first indexed according to an ascending order of the PRB index,
from the N_{type}^{PSFCH} · M_{type}^{PSFCH} PRBs, and then according to an ascending order of the cyclic
shift pair index from the N_{CS}^{PSFCH} cyclic shift pairs.
A UE determines an index of a PSFCH resource for a PSFCH transmission in response to a
PSSCH reception as (P_{ID} + M_{ID} )modR_{PRB, CS}^{PSFCH} where P_{ID} is a physical layer source ID
provided by SCI format 2-A or 2-B [5, TS 38.212] scheduling the PSSCH reception, and
M_{ID} is the identity of the UE receiving the PSSCH as indicated by higher layers if the UE
detects a SCI format 2-A with Cast type indicator field value of “01”; otherwise, M_{ID} is zero.
A UE determines a m₀ value, for computing a value of cyclic shift α [4, TS 38.211], from a
cyclic shift pair index corresponding to a PSFCH resource index and from N_{CS}^{PSFCH} using
Table 16.3-1.

Referring to FIG. 10(a), in step S8040, the first UE may transmit SL HARQ feedback to the BS over the PUCCH and/or PUSCH based on Table 9.

TABLE 9
16.5 UE procedure for reporting HARQ-ACK on uplink
A UE can be provided PUCCH resources or PUSCH resources [12, TS 38.331] to report
HARQ-ACK information that the UE generates based on HARQ-ACK information that the
UE obtains from PSFCH receptions, or from absence of PSFCH receptions. The UE reports
HARQ-ACK information on the primary cell of the PUCCH group, as described in clause 9,
of the cell where the UE monitors PDCCH for detection of DCI format 3_0.
For SL configured grant Type 1 or Type 2 PSSCH transmissions by a UE within a time period
provided by sl-PeriodCG the UE generates one HARQ-ACK information bit in response to
the PSFCH receptions to multiplex in a PUCCH transmissions occasion that is after a last time
resource, in a set of time resources.
For PSSCH transmissions scheduled by a DCI format 3_0, a UE generates HARQ-ACK
information in response to PSFCH receptions to multiplex in a PUCCH transmission occasion
that is after a last time resource in a set of time resources provided by the DCI format 3_0.
From a number of PSFCH reception occasions, the UE generates HARQ-ACK information to
report in a PUCCH or PUSCH transmission. The UE can be indicated by SCI format to
perform one of the following and the UE constructs a HARQ-ACK codeword with HARQ-
ACK information, when applicable

| - for one or more PSFCH reception occasions associated with SCI format 2-A with Cast | |
|---|---|
| type indicator field value of “10” | |
| - | generate HARQ-ACK information with same value as a value of HARQ-ACK |
| | information the UE determines from the last PSFCH reception from the number of |
| | PSFCH reception occasions corresponding to PSSCH transmissions or, if the UE |
| | determines that a PSFCH is not received at the last PSFCH reception occasion and |
| | ACK is not received in any of previous PSFCH reception occasions, generate NACK |
| - for one or more PSFCH reception occasions associated with SCI format 2-A with Cast | |
| type indicator field value of “01” | |
| - | generate ACK if the UE determines ACK from at least one PSFCH reception |
| | occasion, from the number of PSFCH reception occasions corresponding to PSSCH |
| | transmissions, in PSFCH resources corresponding to every identity M_{ID} of the UEs |
| | that the UE expects to receive the PSSCH, as described in clause 16.3; otherwise, |
| | generate NACK |
| - for one or more PSFCH reception occasions associated with SCI format 2-B or SCI | |
| format 2-A with Cast type indicator field value of “11” | |
| - | generate ACK when the UE determines absence of PSFCH reception for the last |
| | PSFCH reception occasion from the number of PSFCH reception occasions |
| | corresponding to PSSCH transmissions; otherwise, generate NACK |

After a UE transmits PSSCHs and receives PSFCHs in corresponding PSFCH resource
occasions, the priority value of HARQ-ACK information is same as the priority value of the
PSSCH transmissions that is associated with the PSFCH reception occasions providing the
HARQ-ACK information.
The UE generates a NACK when, due to prioritization, as described in clause 16.2.4, the UE
does not receive PSFCH in any PSFCH reception occasion associated with a PSSCH
transmission in a resource provided by a DCI format 3_0 or, for a configured grant, in a
resource provided in a single period and for which the UE is provided a PUCCH resource to
report HARQ-ACK information. The priority value of the NACK is same as the priority value
of the PSSCH transmissions.
The UE generates a NACK when, due to prioritization as described in clause 16.2.4, the UE
does not transmit a PSSCH in any of the resources provided by a DCI format 3_0 or, for a
configured grant, in any of the resources provided in a single period and for which the UE is
provided a PUCCH resource to report HARQ-ACK information. The priority value of the
NACK is same as the priority value of the PSSCH that was not transmitted due to
prioritization.
The UE generates an ACK if the UE does not transmit a PSCCH with a SCI format 1-A
scheduling a PSSCH in any of the resources provided by a configured grant in a single period
and for which the UE is provided a PUCCH resource to report HARQ-ACK information. The
priority value of the ACK is same as the largest priority value among the possible priority
values for the configured grant.

### 5QI (5G QoS Identifier)

A 5QI is a scalar used as a reference to 5G QoS characteristics, that is, access node-specific parameters that control QoS forwarding treatment for QoS flows (e.g., scheduling weights, admission thresholds, queue management thresholds, link layer protocol configurations, etc.). Table 10 shows standardized 5QI to QoS characteristics mapping defined in TS 23.501, and the details of this mapping may be found in TS 23.501 as the referenced technical specification. Table 11 shows PQI to QoS characteristics mapping defined in TS 23.287, and the details of this mapping may be found in TS 23.287 as the referenced technical specification. In other words, Table 10 and 11 represent QoS indications for PC5 and Uu links. The QoS for the PC5 link is determined based on PQI values, while the QoS for the Uu link is determined based on 5QI values. Therefore, the QoS-related parameters for each link follow the PQI/5QI values in Tables 10 and 11.

TABLE 10

| | | | | | Default | | |
|---|---|---|---|---|---|---|---|
| | | | | | Maximum | | |
| | | Default | Packet Delay | Packet | Data Burst | Default | |
| 5QI | Resource | Priority | Budget | Error | Volume | Averaging | |
| Value | Type | Level | (NOTE 3) | Rate | (NOTE 2) | Window | Example Services |
| 1 | GBR | 20 | 100 ms | 10⁻² | N/A | 2000 ms | Conversational Voice |
| | | | (NOTE 11, | | | | |
| | | | NOTE 13) | | | | |
| 2 | (NOTE 1) | 40 | 150 ms | 10⁻³ | N/A | 2000 ms | Conversational Video (Live |
| | | | (NOTE 11, | | | | Streaming) |
| | | | NOTE 13) | | | | |
| 3 | | 30 | 50 ms | 10⁻³ | N/A | 2000 ms | Real Time Gaming, V2X messages |
| | | | (NOTE 11, | | | | (see TS 23.287 [121]). |
| | | | NOTE 13) | | | | Electricity distribution - medium |
| | | | | | | | voltage, Process automation |
| | | | | | | | monitoring |
| 4 | | 50 | 300 ms | 10⁻⁶ | N/A | 2000 ms | Non-Conversational Video |
| | | | (NOTE 11, | | | | (Buffered Streaming) |
| | | | NOTE 13) | | | | |
| 65 | | 7 | 75 ms | 10⁻² | N/A | 2000 ms | Mission Critical user plane Push |
| (NOTE 9, | | | (NOTE 7, | | | | To Talk voice (e.g. MCPTT) |
| NOTE 12) | | | NOTE 8) | | | | |
| 66 | | 20 | 100 ms | 10⁻² | N/A | 2000 ms | Non-Mission-Critical user plane |
| (NOTE 12) | | | (NOTE 10, | | | | Push To Talk voice |
| | | | NOTE 13) | | | | |
| 67 | | 15 | 100 ms | 10⁻³ | N/A | 2000 ms | Mission Critical Video user plane |
| (NOTE 12) | | | (NOTE 10, | | | | |
| | | | NOTE 13) | | | | |
| 75 | | | | | | | |
| (NOTE 14) | | | | | | | |
| 71 | | 56 | 150 ms | 10⁻⁶ | N/A | 2000 ms | “Live” Uplink Streaming (e.g. TS |
| | | | (NOTE 11, | | | | 26.238 [76]) |
| | | | NOTE 13, | | | | |
| | | | NOTE 15) | | | | |
| 72 | | 56 | 300 ms | 10⁻⁴ | N/A | 2000 ms | “Live” Uplink Streaming (e.g. TS |
| | | | (NOTE 11, | | | | 26.238 [76]) |
| | | | NOTE 13, | | | | |
| | | | NOTE 15) | | | | |
| 73 | | 56 | 300 ms | 10⁻⁸ | N/A | 2000 ms | “Live” Uplink Streaming (e.g. TS |
| | | | (NOTE 11, | | | | |
| | | | NOTE 13, | | | | 26.238 [76]) |
| | | | NOTE 15) | | | | |
| 74 | | 56 | 500 ms | 10⁻⁸ | N/A | 2000 ms | “Live” Uplink Streaming (e.g. TS |
| | | | (NOTE 11, | | | | 26.238 [76]) |
| | | | NOTE 15) | | | | |
| 76 | | 56 | 500 ms | 10⁻⁴ | N/A | 2000 ms | “Live” Uplink Streaming (e.g. TS |
| | | | (NOTE 11, | | | | 26.238 [76]) |
| | | | NOTE 13, | | | | |
| | | | NOTE 15) | | | | |
| 5 | Non-GBR | 10 | 100 ms | 10⁻⁶ | N/A | N/A | IMS Signalling |
| | | | NOTE 10, | | | | |
| | | | NOTE 13) | | | | |
| 6 | (NOTE 1) | 60 | 300 ms | 10⁻⁶ | N/A | N/A | Video (Buffered Streaming) |
| | | | (NOTE 10, | | | | TCP-based (e.g. www, e-mail, |
| | | | NOTE 13) | | | | chat, ftp, p2p file sharing, |
| | | | | | | | progressive video, etc.) |
| 7 | | 70 | 100 ms | 10⁻³ | N/A | N/A | Voice, |
| | | | (NOTE 10, | | | | Video (Live Streaming) |
| | | | NOTE 13) | | | | Interactive Gaming |
| 8 | | 80 | 300 ms | 10⁻⁶ | N/A | N/A | Video (Buffered Streaming) |
| | | | (NOTE 13) | | | | TCP-based (e.g. www, e-mail, |
| | | | | | | | chat, ftp, p2p file sharing, |
| | | | | | | | progressive |
| 9 | | 90 | | | | | video, etc.) |
| 69 | | 5 | 60 ms | 10⁻⁶ | N/A | N/A | Mission Critical delay sensitive |
| (NOTE 9, | | | (NOTE 7, | | | | signalling (e.g. MC-PTT |
| NOTE 12) | | | NOTE 8) | | | | signalling) |
| 70 | | 55 | 200 ms | 10⁻⁶ | N/A | N/A | Mission Critical Data (e.g. example |
| (NOTE 12) | | | (NOTE 7, | | | | services are the same as 5Q1 6/8/9) |
| | | | NOTE 10) | | | | |
| 79 | | 65 | 50 ms | 10⁻² | N/A | N/A | V2X messages (see TS 23.287 |
| | | | (NOTE 10, | | | | [121]) |
| | | | NOTE 13) | | | | |
| 80 | | 68 | 10 ms | 10⁻⁶ | N/A | N/A | Low Latency eMBB applications |
| | | | (NOTE 5, | | | | Augmented Reality |
| | | | NOTE 10) | | | | |
| 82 | Delay- | 19 | 10 ms | 10⁻⁴ | 255 bytes | 2000 ms | Discrete Automation (see TS |
| | critical | | (NOTE 4) | | | | 22.261 [2]) |
| | GBR | | | | | | |
| 83 | | 22 | 10 ms | 10⁻⁴ | 1354 bytes | 2000 ms | Discrete Automation (see TS |
| | | | (NOTE 4) | | (NOTE 3) | | 22.261 [2]); |
| | | | | | | | V2X messages (UE - RSU |
| | | | | | | | Platooning, Advanced Driving: |
| | | | | | | | Cooperative Lane Change with low |
| | | | | | | | LoA. See TS 22.186 [111], TS |
| | | | | | | | 23.287 [121]) |
| 84 | | 24 | 30 ms | 10⁻⁵ | 1354 bytes | 2000 ms | Intelligent transport systems (see |
| | | | (NOTE 6) | | (NOTE 3) | | TS 22.261 [2]) |
| 85 | | 21 | 5 ms | 10⁻⁵ | 255 bytes | 2000 ms | Electricity Distribution- high |
| | | | (NOTE 5) | | | | voltage (see TS 22.261 [2]). |
| | | | | | | | V2X messages (Remote Driving. |
| | | | | | | | See TS 22.186 [111], NOTE |
| | | | | | | | 16, see TS 23.287 [121]) |
| 86 | | 18 | 5 ms | 10⁻⁴ | 1354 bytes | 2000 ms | V2X messages (Advanced Driving: |
| | | | (NOTE 5) | | | | Collision Avoidance, Platooning |
| | | | | | | | with high LoA. See TS 22.186 |
| | | | | | | | [ 111]. TS 23.287 [121]) |

TABLE 11

| | | Default | Packet | | Packet | Default | Default | |
|---|---|---|---|---|---|---|---|---|
| PQI | Resource | Priority | Delay | | Error | Maximum Data | Averaging | |
| Value | Type | Level | Budget | | Rate | Burst Volume | Window | Example Services |
| 21 | GBR | 3 | 20 | ms | 10⁻⁴ | N/A | 2000 ms | Platooning between UEs - Higher |
| | | | | | | | | degree of automation; |
| | | | | | | | | Platooning between UE and RSU - |
| | | | | | | | | Higher degree of automation |
| 22 | (NOTE 1) | 4 | 50 | ms | 10⁻² | N/A | 2000 ms | Sensor sharing - higher degree of |
| | | | | | | | | automation |
| 23 | | 3 | 100 | ms | 10⁻⁴ | N/A | 2000 ms | Information sharing for automated |
| | | | | | | | | driving - between UEs or UE and |
| | | | | | | | | RSU - higher degree of automation |
| 55 | Non-GBR | 3 | 10 | ms | 10⁻⁴ | N/A | N/A | Cooperative lane change - higher |
| | | | | | | | | degree of automation |
| 56 | | 6 | 20 | ms | 10⁻¹ | N/A | N/A | Platooning informative exchange - |
| | | | | | | | | low degree of automation; |
| | | | | | | | | Platooning - information sharing with |
| | | | | | | | | RSU |
| 57 | | 5 | 25 | ms | 10⁻¹ | N/A | N/A | Cooperative lane change - lower |
| | | | | | | | | degree of automation |
| 58 | | 4 | 100 | ms | 10⁻² | N/A | N/A | Sensor information sharing - lower |
| | | | | | | | | degree of automation |
| 59 | | 6 | 500 | ms | 10⁻¹ | N/A | N/A | Platooning - reporting to an RSU |
| 90 | Delay | 3 | 10 | ms | 10⁻⁴ | 2000 bytes | 2000 ms | Cooperative collision avoidance; |
| | Critical | | | | | | | Sensor sharing - Higher degree of |
| | GBR | | | | | | | automation; |
| | | | | | | | | Video sharing - higher degree of |
| | | | | | | | | automation |
| 91 | (NOTE 1) | 2 | 3 | ms | 10⁻⁵ | 2000 bytes | 2000 ms | Emergency trajectory alignment; |

Sensor sharing - Higher degree of
automation
NOTE 1:
GBR and Delay Critical GBR PQIs can only be used for unicast PC5 communications.

### PDB (Packet Delay Budget)

A PDB defines an upper bound for the amount of time that a packet may be delayed between the UE and the UPF which terminates the N6 interface. For a specific 5QI, the value of the PDB is the same in UL and DL. In the case of 3GPP access, the PDB is used to support the configuration of scheduling and link layer functions (e.g., configuration of scheduling priority weights and HARQ target operating points). For a GBR QoS flow using the delay-critical resource type, if a data burst does not exceed the maximum data burst volume (MDBV) within the PDB period and the QoS flow does not exceed the guaranteed flow bit rate (GFBR), packets delayed more than the PDB are considered lost. For a GBR QoS flow with the GBR resource type, if the QoS flow does not exceed the GFBR, the PDB is interpreted as the maximum delay with a reliability level of 98%. When the SMF adds or modifies a QoS flow for the NG-RAN, the SMF provides various information/parameters regarding the QoS flow. In this case, since the PDB is already determined if a standardized 5QI or pre-configured 5QI is assigned to the QoS flow, the NG-RAN may determine the PDB. If a non-standardized 5QI or not pre-configured 5QI is assigned to the QoS flow, the PDB may be provided to allow the NG-RAN to determine the PDB. The details of the PDB may be found in TS 23.501 v15.4.0 and TS 23.501 v15.4.0.

### CBR (Channel Busy Ratio)

To support effective V2X sidelink communication, a CBR may be defined for congestion measurement on the PC5 interface. The CBR represents the proportion of subchannels whose sidelink received signal strength indicators (S-RSSs), which are observed during a specific time duration (e.g., 100 ms), exceed a configured (or preconfigured) threshold. Table 10 below shows the CBR defined in TS 38.215.

TABLE 12

| | |
|---|---|
| Definition | SL Channel Busy Ratio (SL CBR) measured in slot n is defined as the portion of sub-channels in |
| | the resource pool whose SL RSSI measured by the UE exceed a (pre-)configured threshold |
| | sensed over a CBR measurement window [n-a, n-1], wherein a is equal to 100 or 100 · 2^{μ} slots, |
| | according to higher layer parameter si-TimeWindowSizeCBR. |
| Applicable for | RRC_IDLE intra-frequency, |
| | RRC_IDLE inter-frequency. |
| | RRC_CONNECTED intra-frequency, |
| | RRC_CONNECTED inter-frequency |

Only subchannels included in a resource pool may be used for CBR measurement.

For a UE in Mode 3, the eNB may indicate a set of resources for the UE to perform the CBR measurement. For a UE in mode 4, the UE may perform the CBR measurement in a resource pool specific manner (that is, for each resource pool). The UE may perform the CBR measurement in at least the current transmission resource pool, that is, the transmission resource pool currently used to perform V2X sidelink communication. Whether the UE performs the CBR measurement on transmission resource pools other than the current transmission resource pool is under discussion. The UE may report the results of the CBR measurement to the eNB.

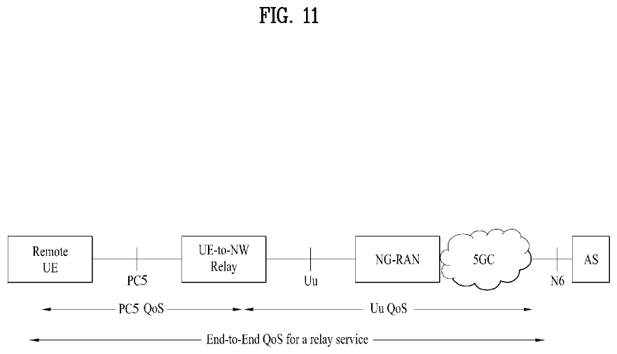

Currently, QoS-related matters are being discussed in 3GPP Rel-17 SI Relay TR (38.836), and FIG. 11 shows details of QoS support for a UE-to-Network relay in 3GPP TR 38.836.

Regarding the UE-to-Network relay, gNB implementation may handle the QoS breakdown over Uu and PC5 for the end-to-end QoS enforcement of a specific session established between the remote UE and network in the case of an L2 UE-to-Network relay.

The present disclosure proposes procedures required for L2 relay operation when the QoS is divided into the PC5 QoS and Uu QoS as in L3 relay operation.

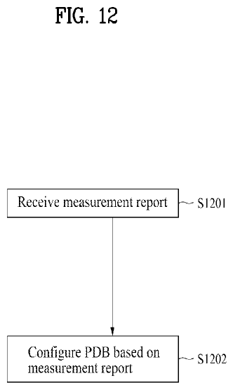

According to an embodiment, a BS may receive a measurement report (S1201 of FIG. 12) and configure a PDB based on the measurement report (S1202 of FIG. 12).

The measurement report may include a result of measuring a CBR, and the PDB may include a PC5 PDB between a relay UE and a remote UE. In addition, the PDB may further include a Uu PDB between the relay UE and the BS. Accordingly, configuring the PDB may include dividing the total PDB into the PC5 PDB and the Uu PDB.

The CBR may be measured by the remote UE and received by the BS from the relay UE.

The BS may increase the PC5 PDB based on an increase in the CBR. The BS may readjust a 5QI/PQI mapping rule capable of reducing the Uu PDB. The PDB may be configured independently for each logical channel, bearer, or service type.

In summary, the BS may receive the CBR of the remote UE through the relay UE, assess the congestion level of the remote UE, and readjust/reallocate the PC5 PDB and the Uu PDB if necessary. Specifically, for example, it is assumed the total PDB of the BS, relay UE, and remote UE is 10 ms and each of the PC5 PDB and Uu PDB is 5 ms before the PDB readjustment. If the congestion level increases in the vicinity of the remote UE due to the following reasons: the mobility of a sidelink UE and so on, resulting in an increase in the CBR, the BS may reallocate the total PDB such that the PC5 PDB and Uu PDB are 7 ms and 3 ms, respectively. When the PC5 PDB and Uu PDB are readjusted/reallocated in consideration of the CBR of the sidelink as described above, the BS may satisfy the total PDB by dynamically reflecting the sidelink communication environment.

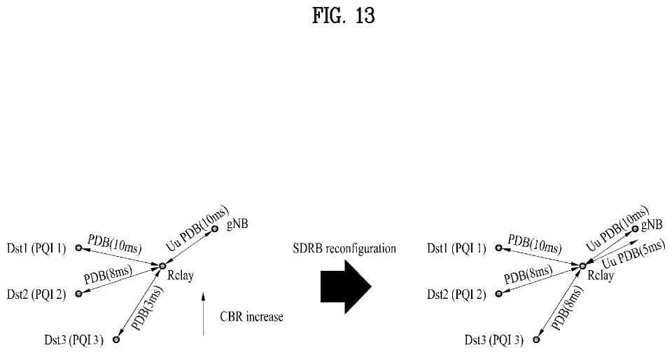

FIG. 13 illustrates an example of reconfiguring a 5QI/PQI mapping rule based on a CBR according to the above-described embodiment.

A BS may configure a 5QI/PQI for each of a Uu link and a sidelink and determine a bearer (mapping) configuration (and/or RLC channel mapping) thereof for a relay UE and a remote UE. The bearer configuration refers to the configuration of which bearer a quality flow identity (QFI) value that may be included in the corresponding bearer is assigned to. In this case, the QFI value represents a value associated with the PQI and 5QI. Since the relay/remote UE is capable of reporting the CBR of a sidelink/Uu link to the BS, the BS may reconfigure the 5QI/PQI mapping rule (or bearer mapping configuration) based on the reported CBR information.

Referring to FIG. 13, it is assumed that the total required PDB from the BS to a destination 3 (Dst 3) remote UE is 13 ms. The PQI between the Dst 3 remote UE and the relay UE is set to value 3, and in this case, the required PDB is assumed to be 3 ms. Additionally, the 5QI may be configured between the relay UE and the BS, and in this case, the required PDB is assumed to be 10 ms.

If the CBR of the sidelink between the Dst 3 remote UE and the relay UE increases, the BS may reconfigure the bearer (mapping) configuration between the sidelink and Uu link after receiving the CBR report from the relay UE. When the CBR of the sidelink increases, it means that the quality of available resources within the same PDB may be degraded. As a result, the transmission success rate of packets transmitted from the Dst 3 to the relay UE may also decrease. Therefore, when performing the bearer (mapping) configuration, the BS may increase the PDB of the sidelink and decrease the PDB of the Uu link by readjusting the 5QI/PQI mapping rule (or bearer mapping configuration), thereby satisfying the overall PDBs from all remote UEs to the BS and improving the transmission success rate. In this case, the PDB may be independently configured or determined for each logical channel, bearer, or service type. The relay UE may be an L2 relay.

In relation to the above-described embodiments, a BS (apparatus) is provided. The BS may include: at least one processor; and at least one computer memory operably connected to the at least one processor and configured to store instructions that, when executed, cause the at least one processor to perform operations. The operations may include: receiving a measurement report; and configuring a PDB based on the measurement report. The measurement report may include a result of measuring a CBR, and the PDB may include a PC5 PDB between a relay UE and a remote UE.

In addition, there is provided a processor configured to perform operations for a BS. The operations may include: receiving a measurement report; and configuring a PDB based on the measurement report. The measurement report may include a result of measuring a CBR, and the PDB may include a PC5 PDB between a relay UE and a remote UE.

Further, there is provided a non-volatile computer-readable storage medium configured to store at least one computer program including instructions that, when executed by at least one processor, cause the at least one processor to perform operations for a Base station. The operations may include: receiving a measurement report; and configuring a PDB based on the measurement report. The measurement report may include a result of measuring a CBR, and the PDB may include a PC5 PDB between a relay UE and a remote UE.

In relation to the above-described embodiments, a method of operating a relay UE is provided. The method may include: transmitting a measurement report to a BS; and receiving a PDB configuration based on the measurement report from the BS. The measurement report may include a result of measuring a CBR, and the PDB may include a PC5 PDB between the relay UE and a remote UE.

In addition, there is provided a relay UE (apparatus). The relay UE may include: at least one processor; and at least one computer memory operably connected to the at least one processor and configured to store instructions that, when executed, cause the at least one processor to perform operations. The operations may include: transmitting a measurement report to a BS; and receiving a PDB configuration based on the measurement report from the BS. The measurement report may include a result of measuring a CBR, and the PDB may include a PC5 PDB between the relay UE and a remote UE.

The details of the BS (apparatus), processor, non-volatile computer-readable storage medium, relay UE operation method, and relay UE could be replaced with the aforementioned content.

Hereinafter, methods for assessing other sidelink qualities except for the CBR will be described. The following embodiments are related to methods for the remote UE to transmit a message requesting a bearer (mapping) configuration to the BS rather than the above-described method in which the BS determines the CBR of a sidelink/Uu link and transmits information on the bearer (mapping) configuration to the relay and remote UEs. The remote UE may transmit a message recommending the bearer (mapping) configuration to the BS in the following situations.
If the remote UE receives/transmits NACK signals continuously for a certain number of times (within a specified time period) in the communication between the remote UE and the relay UE,
(and/or) if the remote UE detects discontinuous transmission (DTX) signals continuously for a certain number of times (within a specified time period) in the communication between the remote UE and the relay UE.

In the above case, when transmitting the message recommending/requesting the bearer (mapping) configuration (PQI/5QI mapping configuration) to the BS, the relay UE may also transmit the number of consecutive NACKs and/or the number of times that DTX consecutively occurs (history value) between the relay UE and the remote UE along with a value capable of identifying the corresponding remote UE (e.g., a PC5 identification, a local ID capable of informing the remote UE, a link ID, etc.). Upon receiving the recommendation message, the BS may reallocate resources used for the sidelink or reconfigure a bearer mapping rule (or PQI/5QI mapping rule).

Hereinafter, methods of reducing a time required to reconfigure the bearer mapping rule will be described together with or independently of the above-described embodiments.

When the relay UE reports the quality of a sidelink to the BS and receives related reconfiguration information, the overall process may take a long time. However, according to the proposed methods, the BS may preconfigure a different bearer mapping rule (or 5QI/PQI mapping rule) for each CBR range (or each range of the number of consecutive sidelink NACK/DTX events) to the remote/relay UE. If a measured CBR value falls within a predefined CBR range (or a predefined range of the number of consecutive sidelink NACK/DTX events), the relay/remote UE may select a configuration related to the corresponding value from among pre-allocated configurations and informs the BS that the selected configuration will be applied. Then, the remote/relay UE may reconfigure the bearer mapping rule (or 5QI/PQI mapping rule) by applying the selected configuration. Accordingly, the BS may know which bearer mapping rule (or 5QI/PQI mapping rule) among the preconfigured mapping rules the relay/remote UE will use to transmit packets. Therefore, the BS does not need to transmit any reconfiguration messages, thereby reducing the time required to apply the new rule.

When the remote UE establishes a connection with the gNB, the gNB performs a bearer configuration for the remote UE and also performs a bearer mapping configuration for the relay UE (adaptation layer). In this case, if the relay UE and remote UE report the state of a sidelink (SL) channel, the gNB expects to effectively break down the Uu link QoS and the sidelink QoS depending on the end-to-end QoS requirements of services to be transmitted or received during the bearer (mapping) configuration for the remote UE and relay UE.

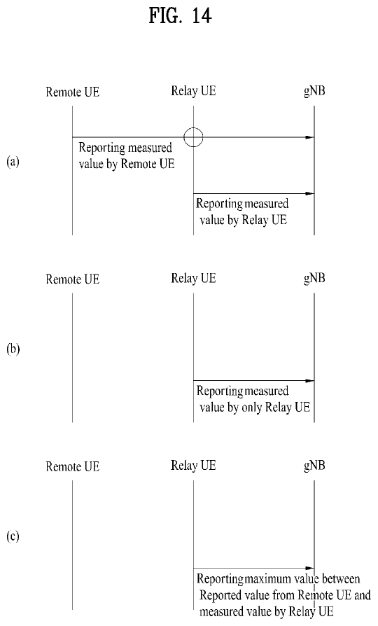

The methods shown in FIGS. 14(a) to 14(c) may be considered to report a SL channel state. In this case, the SL channel state may refer to the CBR and the number of consecutive NACK/DTX events. In addition, if the SL channel state exceeds a configured (or preconfigured) threshold, the remote/relay UE may be configured to report related information to the BS.

Referring to FIG. 14(a), each of the relay UE and remote UE reports its measured SL channel environment.

Referring to FIG. 14(b), the relay UE assumes that the relay UE and remote UE are located in close proximity and reports only the SL channel environment measured by the relay UE. In this method, the relay UE assumes that the SL channel environment of the remote UE is nearly identical to that measured by the relay UE. Since there is no process for the remote UE to directly report the SL channel environment to the BS, the method may be straightforward.

Referring to FIG. 14(c), the remote UE reports the SL channel environment only to the relay UE. Then, the relay UE compares the value received from the remote UE with its own measured value and reports the greater or smaller value to the BS. Considering that the relay UE receives the report on the SL channel environment from the remote UE, compares the report with its own measured value, and then provides a processed value to the gNB, this method may be an optimized method for reducing reporting overhead while improving the accuracy of measurements.

Hereinafter, a relay selection procedure that may be required when the relay UE is selected based on sidelink discovery reference signal received power (SD-RSRP) and sidelink reference signal received power (SL-RSRP), which is different from that in the prior art, will be described. In addition, priorities related to relay selection will be also described. In the prior art, when the remote UE intends to select the relay UE, the remote UE relies on the signal strength of a discovery message (SD-RSRP) to make the selection. However, when the relay UE and remote UE establish a PC5-S/PC5-RRC connection only for sidelink operation rather than relay operation, the unicast signal strength (SL-RSRP) used for mutual communication may be used to select the relay. In the following, this will be described in detail.

If the remote UE is currently performing SL unicast with a candidate relay UE, a procedure for relay selection may be performed as follows.

The relay UE and remote UE may exchange their relay capabilities in PC5-RRC messages. For example, a (remote) UE expected to request relay operation may request a peer UE to transmit the relay capability of the peer UE via a UECapabilityEnquirySidelink field in a PC5-RRC message, and/or a (relay) UE having the relay capability may inform a peer UE of its own relay capability via a UECapabilitylnformationSidelink field in a PC5-RRC message. In this case, the UECapabilityEnquirySidelink or UECapabilitylnformationSidelink field may also include information such as the type of service capable of being relayed or desired to be relayed, a cell ID, a load level, an RRC CONNECTED state, and so on.

If the remote UE is currently performing the SL unicast with the candidate relay UE, the remote UE may estimate whether the QoS (quality) requirements of a service that the remote UE desires to provide through relay operation are meet, based on the signal strength (SL-RSRP) of the SL unicast. When the remote UE determines that the peer UE, which the remote UE is currently establishing the PC5-RRC connection with, has the relay capability and the remote UE is capable of satisfying the QoS requirements of the service that the remote UE desires to provide through the relay UE, the remote UE may directly transmit an RRC Setup message to the peer UE without requesting a Discovery Request (Discovery Solicitation) message. Upon receiving the RRC Setup message, the peer UE may know that the message is for the relay operation and relay the message to the BS (gNB). At this time, if the peer UE serving as the relay is in the RRC IDLE/INACTIVE state, the peer UE performs an operation for establishing a connection with the gNB.

The above-described operation of initiating relaying by selecting the relay UE may correspond to a method of initiating relay operation without the use of Discovery messages, which differs in structure from a procedure for initiating relaying based on Discovery Model A/B.

Hereinafter, a procedure for relay (re-)selection when the remote UE is currently performing the SL unicast with the candidate relay UE will be described.

If the remote UE needs to perform relay (re-)selection in a state that the remote UE has SL unicast connections established with multiple other UEs only for pure SL unicast communication, the remote UE may perform the relay (re-)selection based on SD-RSRP (RSRP measured based on Discovery messages) and SL-RSRP (RSRP measured based on an SL unicast link). In this case, if there is a candidate relay UE among the UEs having the SL unicast connections established with the remote UE, the remote UE may prioritize selecting the corresponding candidate relay UE. The presence of the candidate relay UE may be determined based on related information included in a PC5-RRC messages as described above or based on Discovery messages.

For example, the remote UE may measure the SD-RSRP of candidate relay UEs. Then, the remote UE may select, as the relay UE, a UE having a PC5-RRC connection established with the remote UE from among candidate relay UEs having SD-RSRP that exceeds a certain (predetermined) threshold. This operation may offer advantages in terms of load, latency, and power saving compared to establishing a new PC5-RRC connection for relay operation.

Alternatively, if there is a candidate relay UE having a PC5-RRC connection established with the remote UE, and more particularly, if there is a UE with the relay capability among UEs having PC5-RRC connections established with the remote UE, the remote UE may decode only a Discovery message transmitted from the UE. If the SD-RSRP value exceeds a certain (predetermined) threshold, the remote UE may select the corresponding UE as the relay UE.

Alternatively, different thresholds may be applied to the SD-RSRP value transmitted by a candidate relay UE having a PC5-RRC connection and the SD-RSRP value transmitted by a candidate relay UE having no PC5-RRC connection. Specifically, the threshold for the SD-RSRP value transmitted by the candidate relay UE with the PC5-RRC connection may be set lower than the threshold for the SD-RSRP value transmitted by the candidate relay UE with no PC5-RRC connection. Thus, even if the SD-RSRP value of the UE with the PC5-RRC connection is slightly worse, selecting the UE with the PC5-RRC connection may be implicitly prioritized.

When the remote UE selects a final relay UE from among candidate UEs with PC5-RRC connections, the remote UE may use SL CSI (as well as the signal strength related to SL unicast (e.g., SL-RSRP)). For example, if the difference in SL-RSRP signal strength between candidate relay UEs with PC5-RRC connections established with the remote UE falls within a predetermined threshold, the remote UE may select the final relay UE based on values in the SL CSI.

When selecting the final relay UE among multiple candidate relay UEs with established PC5-RRC connections (CON_RELUE) and multiple candidate relay UEs without established PC5-RRC connections (DIS_RELUE), the remote UE may compare the minimum link quality (e.g., RSRP) of DIS_RELUE with the minimum link quality of CON_RELUE. If the difference between the two minimum link qualities is less than or equal to a predetermined threshold, the remote UE may select the final relay UE from CON_RELUE (i.e., prioritizing CON_RELUE). On the other hand, if the minimum link quality of DIS_RELUE exceeds the minimum link quality of CON_RELUE by a predetermined threshold or more, the remote UE may be configured to select the final relay UE from both DIS_RELUE and CON_RELUE (or from DIS_RELUE, i.e., prioritizing DIS_RELUE). In this case, it is assumed that both CON_RELUE and DIS_RELUE exceed a predetermined minimum quality threshold (which is configured either commonly or separately).

When a candidate relay UE with a PC5-RRC connection with a peer UE transmits a Discovery messages to the peer UE with which the PC5-RRC connection is established, the candidate relay UE may be configured to designate a relevant (L1 or L2) source ID (and/or destination ID) as a value used for communication with the peer UE with which the PC5-RRC connection is established (for example, this value may be configured or designated to be different from that used to transmit a Discovery messages to other (or all) UEs) (additionally/alternatively, reserved bits in SCI may have predetermined values to distinguish the Discovery message from other messages). For example, when the above rule is applied, the peer UE may obtain discovery/relay related (service) information from the corresponding Discovery message received from the candidate relay UE.

### Examples of Communication Systems Applicable to the Present Disclosure

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

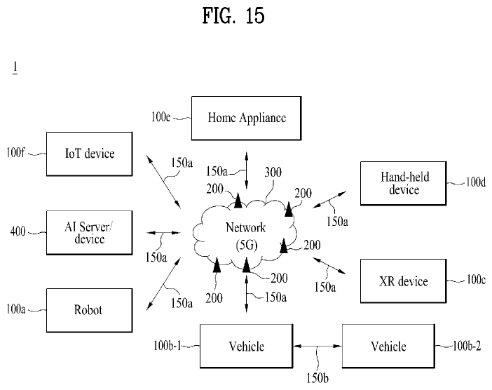

FIG. 15 illustrates a communication system 1 applied to the present disclosure.

Referring to FIG. 15, a communication system 1 applied to the present disclosure includes wireless devices, BSs, and a network. Herein, the wireless devices represent devices performing communication using RAT (e.g., 5G NR or LTE) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of things (IoT) device 100f, and an artificial intelligence (AI) device/server 400. For example, the vehicles may include a vehicle having a wireless communication function, an autonomous driving vehicle, and a vehicle capable of performing communication between vehicles. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. V2V/V2X communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as UL/DL communication 150a, sidelink communication 150b (or, D2D communication), or inter BS communication (e.g. relay, integrated access backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

### Examples of Wireless Devices Applicable to the Present Disclosure

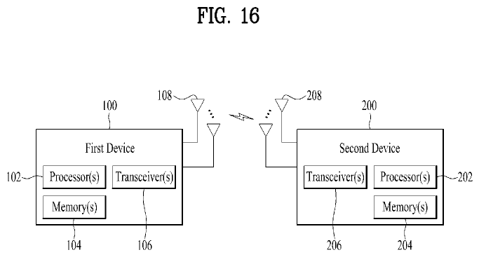

FIG. 16 illustrates wireless devices applicable to the present disclosure.

Referring to FIG. 16, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 15.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more service data unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands

The one or more memories 104 and 204 may be connected to the one or more processors 102 and 202 and store various types of data, signals, messages, information, programs, code, instructions, and/or commands The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of a vehicle or an autonomous driving vehicle applicable to the present disclosure

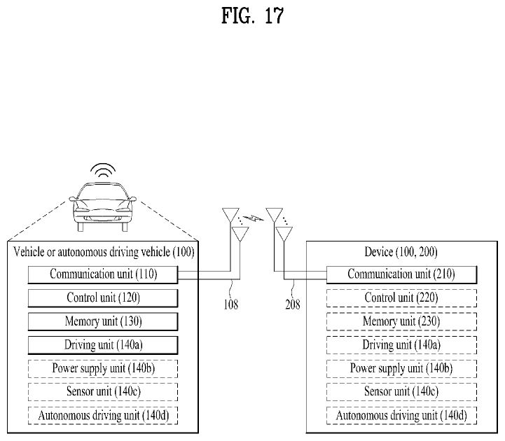

FIG. 17 illustrates a vehicle or an autonomous driving vehicle applied to the present disclosure. The vehicle or autonomous driving vehicle may be implemented by a mobile robot, a car, a train, a manned/unmanned aerial vehicle (AV), a ship, etc.

Referring to FIG. 17, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

### Examples of a Vehicle and AR/VR Applicable to the Present Disclosure

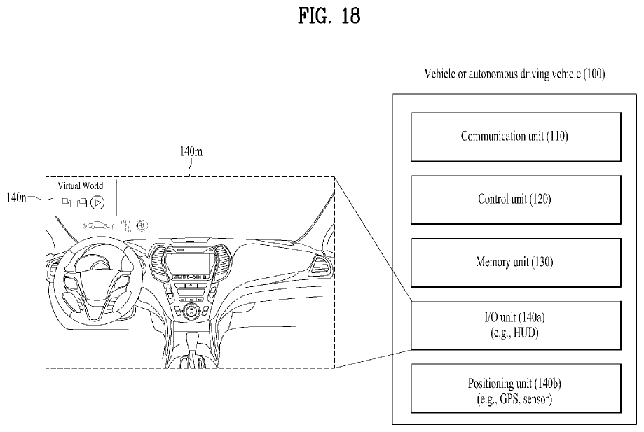

FIG. 18 illustrates a vehicle applied to the present disclosure. The vehicle may be implemented as a transport means, an aerial vehicle, a ship, etc.

Referring to FIG. 18, a vehicle 100 may include a communication unit 110, a control unit 120, a memory unit 130, an I/O unit 140a, and a positioning unit 140b.

The communication unit 110 may transmit and receive signals (e.g., data and control signals) to and from external devices such as other vehicles or BSs. The control unit 120 may perform various operations by controlling constituent elements of the vehicle 100. The memory unit 130 may store data/parameters/programs/code/commands for supporting various functions of the vehicle 100. The I/O unit 140a may output an AR/VR object based on information within the memory unit 130. The I/O unit 140a may include an HUD. The positioning unit 140b may acquire information about the position of the vehicle 100. The position information may include information about an absolute position of the vehicle 100, information about the position of the vehicle 100 within a traveling lane, acceleration information, and information about the position of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain the vehicle position information through the GPS and various sensors and store the obtained information in the memory unit 130. The control unit 120 may generate a virtual object based on the map information, traffic information, and vehicle position information and the I/O unit 140a may display the generated virtual object in a window in the vehicle (1410 and 1420). The control unit 120 may determine whether the vehicle 100 normally drives within a traveling lane, based on the vehicle position information. If the vehicle 100 abnormally exits from the traveling lane, the control unit 120 may display a warning on the window in the vehicle through the I/O unit 140a. In addition, the control unit 120 may broadcast a warning message regarding driving abnormity to neighboring vehicles through the communication unit 110. According to situation, the control unit 120 may transmit the vehicle position information and the information about driving/vehicle abnormality to related organizations.

### Examples of an XR Device Applicable to the Present Disclosure

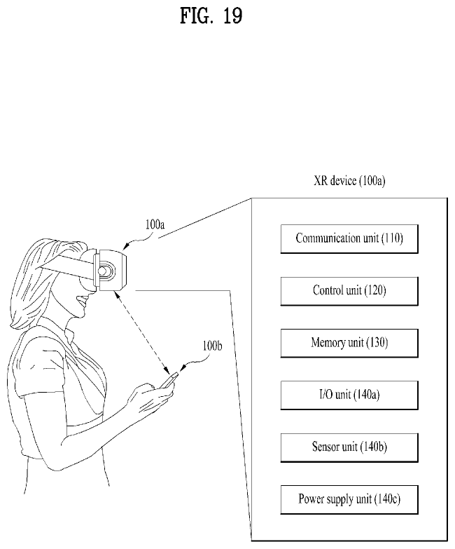

FIG. 19 illustrates an XR device applied to the present disclosure. The XR device may be implemented by an HMD, an HUD mounted in a vehicle, a television, a smartphone, a computer, a wearable device, a home appliance, a digital signage, a vehicle, a robot, etc.

Referring to FIG. 19, an XR device 100a may include a communication unit 110, a control unit 120, a memory unit 130, an I/O unit 140a, a sensor unit 140b, and a power supply unit 140c.

The communication unit 110 may transmit and receive signals (e.g., media data and control signals) to and from external devices such as other wireless devices, hand-held devices, or media servers. The media data may include video, images, and sound. The control unit 120 may perform various operations by controlling constituent elements of the XR device 100a. For example, the control unit 120 may be configured to control and/or perform procedures such as video/image acquisition, (video/image) encoding, and metadata generation and processing. The memory unit 130 may store data/parameters/programs/code/commands needed to drive the XR device 100a/generate XR object. The I/O unit 140a may obtain control information and data from the exterior and output the generated XR object. The I/O unit 140a may include a camera, a microphone, a user input unit, a display unit, a speaker, and/or a haptic module. The sensor unit 140b may obtain an XR device state, surrounding environment information, user information, etc. The sensor unit 140b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 140c may supply power to the XR device 100a and include a wired/wireless charging circuit, a battery, etc.

For example, the memory unit 130 of the XR device 100a may include information (e.g., data) needed to generate the XR object (e.g., an AR/VR/MR object). The I/O unit 140a may receive a command for manipulating the XR device 100a from a user and the control unit 120 may drive the XR device 100a according to a driving command of a user. For example, when a user desires to watch a film or news through the XR device 100a, the control unit 120 transmits content request information to another device (e.g., a hand-held device 100b) or a media server through the communication unit 130. The communication unit 130 may download/stream content such as films or news from another device (e.g., the hand-held device 100b) or the media server to the memory unit 130. The control unit 120 may control and/or perform procedures such as video/image acquisition, (video/image) encoding, and metadata generation/processing with respect to the content and generate/output the XR object based on information about a surrounding space or a real object obtained through the I/O unit 140a/sensor unit 140b.

The XR device 100a may be wirelessly connected to the hand-held device 100b through the communication unit 110 and the operation of the XR device 100a may be controlled by the hand-held device 100b. For example, the hand-held device 100b may operate as a controller of the XR device 100a. To this end, the XR device 100a may obtain information about a 3D position of the hand-held device 100b and generate and output an XR object corresponding to the hand-held device 100b.

### Examples of a Robot Applicable to the Present Disclosure

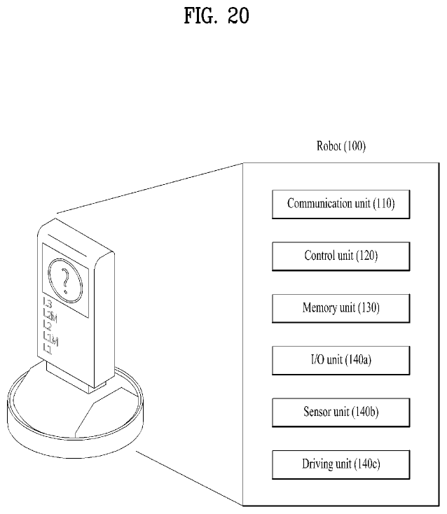

FIG. 20 illustrates a robot applied to the present disclosure. The robot may be categorized into an industrial robot, a medical robot, a household robot, a military robot, etc., according to a used purpose or field.

Referring to FIG. 20, a robot 100 may include a communication unit 110, a control unit 120, a memory unit 130, an I/O unit 140a, a sensor unit 140b, and a driving unit 140c. Herein, the blocks 110 to 130/140a to 140c correspond to the blocks 110 to 130/140 of FIG. 16, respectively.

The communication unit 110 may transmit and receive signals (e.g., driving information and control signals) to and from external devices such as other wireless devices, other robots, or control servers. The control unit 120 may perform various operations by controlling constituent elements of the robot 100. The memory unit 130 may store data/parameters/programs/code/commands for supporting various functions of the robot 100. The I/O unit 140a may obtain information from the exterior of the robot 100 and output information to the exterior of the robot 100. The I/O unit 140a may include a camera, a microphone, a user input unit, a display unit, a speaker, and/or a haptic module. The sensor unit 140b may obtain internal information of the robot 100, surrounding environment information, user information, etc. The sensor unit 140b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 140c may perform various physical operations such as movement of robot joints. In addition, the driving unit 140c may cause the robot 100 to travel on the road or to fly. The driving unit 140c may include an actuator, a motor, a wheel, a brake, a propeller, etc.

### Example of AI Device to Which the Present Disclosure is Applied

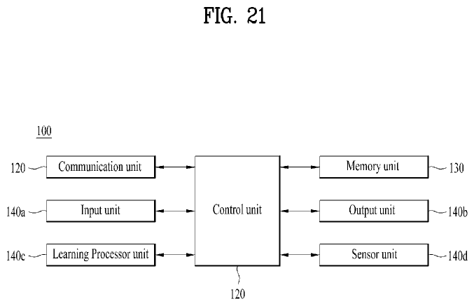

FIG. 21 illustrates an AI device applied to the present disclosure. The AI device may be implemented by a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. 21, an AI device 100 may include a communication unit 110, a control unit 120, a memory unit 130, an I/O unit 140a/140b, a learning processor unit 140c, and a sensor unit 140d. The blocks 110 to 130/140a to 140d correspond to blocks 110 to 130/140 of FIG. 16, respectively.

The communication unit 110 may transmit and receive wired/radio signals (e.g., sensor information, user input, learning models, or control signals) to and from external devices such as other AI devices (e.g., 100x, 200, or 400 of FIG. 15) or an AI server (e.g., 400 of FIG. 15) using wired/wireless communication technology. To this end, the communication unit 110 may transmit information within the memory unit 130 to an external device and transmit a signal received from the external device to the memory unit 130.

The control unit 120 may determine at least one feasible operation of the AI device 100, based on information which is determined or generated using a data analysis algorithm or a machine learning algorithm. The control unit 120 may perform an operation determined by controlling constituent elements of the AI device 100. For example, the control unit 120 may request, search, receive, or use data of the learning processor unit 140c or the memory unit 130 and control the constituent elements of the AI device 100 to perform a predicted operation or an operation determined to be preferred among at least one feasible operation. The control unit 120 may collect history information including the operation contents of the AI device 100 and operation feedback by a user and store the collected information in the memory unit 130 or the learning processor unit 140c or transmit the collected information to an external device such as an AI server (400 of FIG. 15). The collected history information may be used to update a learning model.

The memory unit 130 may store data for supporting various functions of the AI device 100. For example, the memory unit 130 may store data obtained from the input unit 140a, data obtained from the communication unit 110, output data of the learning processor unit 140c, and data obtained from the sensor unit 140. The memory unit 130 may store control information and/or software code needed to operate/drive the control unit 120.

The input unit 140a may acquire various types of data from the exterior of the AI device 100. For example, the input unit 140a may acquire learning data for model learning, and input data to which the learning model is to be applied. The input unit 140a may include a camera, a microphone, and/or a user input unit. The output unit 140b may generate output related to a visual, auditory, or tactile sense. The output unit 140b may include a display unit, a speaker, and/or a haptic module. The sensing unit 140 may obtain at least one of internal information of the AI device 100, surrounding environment information of the AI device 100, and user information, using various sensors. The sensor unit 140 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 140c may learn a model consisting of artificial neural networks, using learning data. The learning processor unit 140c may perform AI processing together with the learning processor unit of the AI server (400 of FIG. 15). The learning processor unit 140c may process information received from an external device through the communication unit 110 and/or information stored in the memory unit 130. In addition, an output value of the learning processor unit 140c may be transmitted to the external device through the communication unit 110 and may be stored in the memory unit 130.

### INDUSTRIAL APPLICABILITY

The above-described embodiments of the present disclosure are applicable to various mobile communication systems.

1-14. (canceled)

15. A method of operating a base station (BS) in a wireless communication system, the method comprising:
configuring, by the base station, bearers for uplink transmission of a remote UE via a relay UE,
receiving, by the base station, a packet from the remote UE through the relay UE,
wherein the configuring of the bearers is based on:
transmitting a first configuration related to a first bearer of a PC5 link between the remote UE and the relay UE to the remote UE, and
transmitting a second configuration related to a second bearer of a Uu link between the relay UE and the base station to the relay UE.

16. A base station (BS) in a wireless communication system, the BS comprising:
at least one processor; and
at least one computer memory operably connected to the at least one processor and configured to store instructions that, when executed, cause the at least one processor to perform operations comprising:
configuring bearers for uplink transmission of a remote UE via a relay UE,
receiving a packet from the remote UE through the relay UE,
wherein the configuring of the bearers is based on:
transmitting a first configuration related to a first bearer of a PC5 link between the remote UE and the relay UE to the remote UE, and
transmitting a second configuration related to a second bearer of a Uu link between the relay UE and the base station to the relay UE.

17. A processor configured to perform operations for a base station (BS) in a wireless communication system, the operations comprising:
configuring bearers for uplink transmission of a remote UE via a relay UE,
receiving a packet from the remote UE through the relay UE,
wherein the configuring of the bearers is based on:
transmitting a first configuration related to a first bearer of a PC5 link between the remote UE and the relay UE to the remote UE, and
transmitting a second configuration related to a second bearer of a Uu link between the relay UE and the base station to the relay UE.

18. A non-volatile computer-readable storage medium configured to store at least one computer program comprising instructions that, when executed by at least one processor, cause the at least one processor to perform operations for a base station, the operations comprising:
configuring bearers for uplink transmission of a remote UE via a relay UE,
receiving a packet from the remote UE through the relay UE,
wherein the configuring of the bearers is based on:
transmitting a first configuration related to a first bearer of a PC5 link between the remote UE and the relay UE to the remote UE, and
transmitting a second configuration related to a second bearer of a Uu link between the relay UE and the base station to the relay UE.

19. A method of operating a relay user equipment (UE) in a wireless communication system, the method comprising:
receiving, by the relay UE from a base station, a second configuration related to a second bearer of a Uu link between the relay UE and the base station;
receiving, by the relay UE, a packet from a remote UE;
transmitting, by the relay UE, the received packet to the base station,
wherein the reception of the second configuration by the relay UE and a reception of a first configuration related to a first bearer of a PC5 link between the remote UE and the relay UE by the remote UE are related to a configuration of bearers for uplink transmission of the remote UE via the relay UE.

20. A relay user equipment (UE) in a wireless communication system, the relay UE comprising:
at least one processor; and
at least one computer memory operably connected to the at least one processor and configured to store instructions that, when executed, cause the at least one processor to perform operations comprising:
receiving, from a base station, a second configuration related to a second bearer of a Uu link between the relay UE and the base station;
receiving a packet from a remote UE;
transmitting the received packet to the base station,
wherein the reception of the second configuration by the relay UE and a reception of a first configuration related to a first bearer of a PC5 link between the remote UE and the relay UE by the remote UE are related to a configuration of bearers for uplink transmission of the remote UE via the relay UE.

21. The relay UE of claim 20, wherein the relay UE communicates with at least one of another UE, a UE related to an autonomous vehicle, a BS, or a network.
